(19) United States
(12) Patent Application Publication
(10) Pub. No.: US 2006/0213541 A1
(43) Pub. Date: Sep. 28, 2006

(54) Apparatus and method for cleaning bottles

(75) Inventor: Michael S. Burgess, Negley, OH (US)

Correspondence Address: THE WEBB LAW FIRM, P.C., 700 KOPPERS BUILDING, 436 SEVENTH AVENUE, PITTSBURGH, PA, 15219, US

(73) Assignee: Renal Clean Technology, Youngstown, OH (US)

(21) Appl. No.: 11/338,613

(22) Filed: Jan. 24, 2006

Related U.S. Application Data
(60) Provisional application No. 60/646,361, filed on Jan. 24, 2005.

(51) Int. Cl. B08B 9/00; B08B 9/20; B08B 3/00

(52) U.S. Cl. 134/22.12; 134/22.1; 134/25.1; 134/166 R; 134/198

(57) ABSTRACT

A bottle cleaner has a bottle holder adapted to hold at least one bottle in an inverted position, a source line connected to a spray line for introducing source fluid into the interior of the at least one bottle, a cleaning line selectively fluidly connected to the source line for introducing cleaning fluid with the source fluid into the at least one bottle, and a valve having at least two positions wherein. In a first position, a cleaning mode is activated wherein the cleaning line is fluidly connected to the source line so that cleaning fluid and source fluid may be combined and supplied to the spray line. In a second position, a rinse mode is activated wherein only fluid from the source line may be supplied to the spray line. A drain line drains away the fluid exiting the bottles. A method for cleaning bottles is also disclosed.

### CROSS REFERENCE TO RELATED APPLICATIONS

This application claims the benefit of U.S. Provisional Patent Application No. 60/646,361, filed Jan. 24, 2005.

### BACKGROUND OF THE INVENTION

1. Field of the Invention

The present invention relates to an improved bottle washer for washing multiple bottles that may be different sizes, wherein at a single station a bottle may be cleaned and rinsed.

2. Description of Related Art

During a dialysis procedure, a concentrated solution of sodium bicarbonate is used that, when diluted with water and acid concentrate, makes dialysate used for dialysis. The concentrated solution is placed in large bottles for use in dialysis machines. Soon after using, the bottles must be disinfected and rinsed to remove any residual bicarbonate and to control the proliferation of micro-organisms to meet the standards set forth by the Association for the Advancement of Medical Instrumentation (AAMI).

In the past, it was necessary to manually clean these bottles by first squirting a bleach solution inside, letting the bleach sit for approximately 10 minutes, filling up the jugs with a rinsing fluid, and then rinsing out the jugs by emptying the rinse fluid. This procedure was required for each bottle and, as a result, in a typical procedure which involves a large number of bottles, a substantial amount of labor was required. A method is needed whereby bottles may be cleaned in a more efficient manner using less labor and less time.

### BRIEF SUMMARY OF THE INVENTION

The invention is directed to a bottle cleaner comprising a bottle holder adapted to hold at least one bottle in an inverted position, a source line connected to a spray line for introducing source fluid into the interior of the at least one bottle, a cleaning line selectively fluidly connected to the source line for introducing cleaning fluid with the source fluid into the at least one bottle, and a valve having at least two positions. In a valve first position, a cleaning mode is activated wherein the cleaning line is fluidly connected to the source line so that cleaning fluid and source fluid may be combined and supplied to the spray line. In a valve second position, a rinse mode is activated wherein only fluid from the source line may be supplied to the spray line. The bottle cleaner may accommodate a plurality of bottles for cleaning.

### BRIEF DESCRIPTION OF THE SEVERAL VIEWS OF THE DRAWINGS

FIG. 1 illustrates a schematic of the bottle cleaner in the cleaning mode;

FIG. 2 illustrates a schematic of the bottle cleaner in the rinse mode;

FIG. 3 is a sketch of the bottle cleaner with a single bottle in place;

FIG. 4 is a sketch looking down into a bottle holder, without a bottle therein;

FIG. 5 is a perspective view of a portion of the bottle holder illustrating the manner in which a bottle may be supported; and

FIG. 6 is a cutaway side view of the replaceable segment illustrated in FIG. 3.

### DETAILED DESCRIPTION OF THE INVENTION

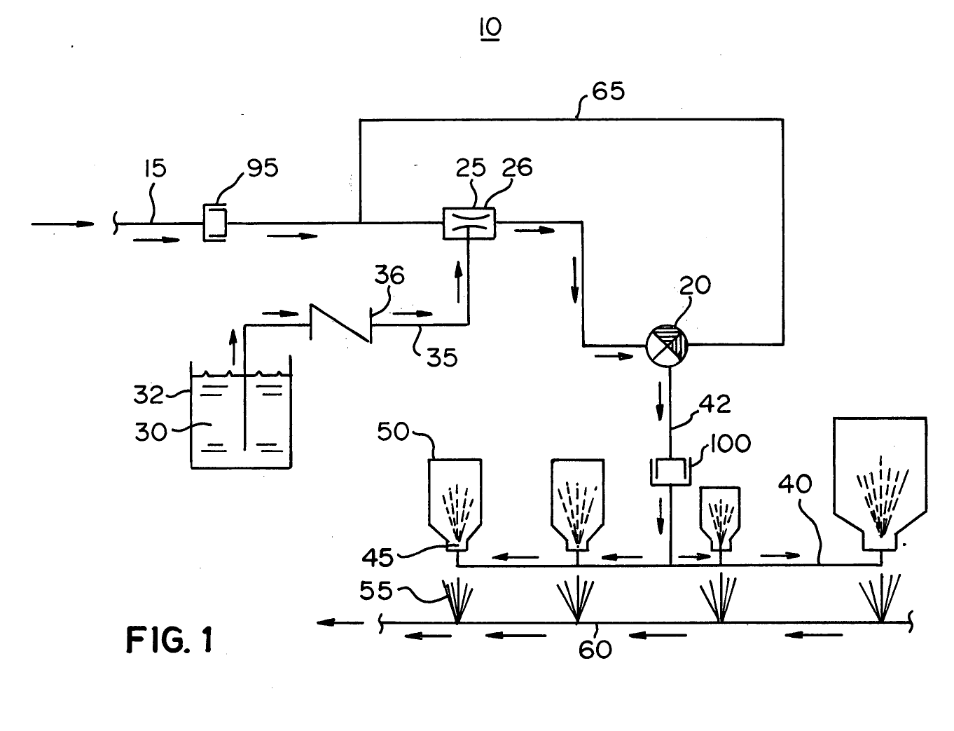

The bottle cleaner 10, in accordance with the subject invention, operates in three modes. In particular, and with attention directed to FIG. 1, water or another source fluid is introduced through the source line 15 and, depending upon the position of the valve 20, the cleaning mode, the rinse mode or shut-down mode is activated. In FIG. 1, the valve 20 permits the source fluid from the source line 15 to travel through a mixer, such as a Venturi tube 25. A cleaning fluid 30 is connected by a cleaning line 35 to the throat of the Venturi tube 25, such that the Venturi tube 25 mixes source fluid from the source line 15 with cleaning fluid from the cleaning line 35. In one example, the cleaning fluid 30 is bleach and the source fluid traveling through the source line 15 is water such that a bleach/water solution travels through the valve 20 and through a spray line 42 into a manifold 40 where it is distributed through individual spray nozzles 45 which spray the fluid into the interior of the at least one bottle 50 to be cleaned. The manifold 40 is located between the source line 15 and the spray nozzle 45 extending therefrom. As illustrated, the bottles 50 are in an inverted position. The source line 15 may provide tap water under pressure.

The Venturi tube 25 acts as a mixer and is located at the intersection of the source line 15 and the cleaning line 35. In particular, the Venturi tube 25 is a standard commercially available part well known to those skilled in the art of fluid flow and is comprised of a body 26 adapted for primary flow longitudinally through the body 26 of the tube 25 and for secondary flow laterally into the body 26. The source line 15 is aligned with the primary flow and the cleaning line 35 is aligned with the secondary flow such that the secondary flow is introduced into the body 26 from the vacuum produced by primary flow through the Venturi tube 25.

A mixer may also be located downstream of the intersection of the source line 15 and the cleaning line 35.

By gravity, the fluid sprayed into the bottles 50 falls into the bottle holders 55 connected to a drain line 60, which is below the bottle holder 55, where the fluid is drained away.

In the valve first position, illustrated in FIG. 1, the cleaning mode is activated wherein the cleaning line 35 is fluidly connected to the source line 15 so that cleaning fluid and source fluid may be combined and supplied to the spray line 42, which is connected to the spray nozzles 45.

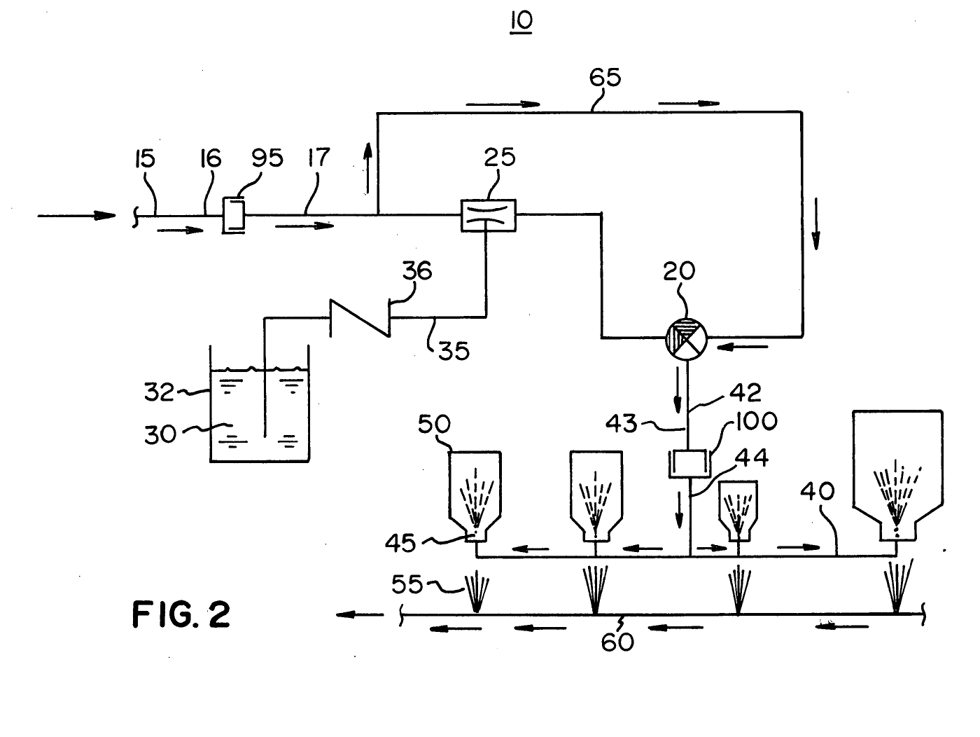

In the valve second position, illustrated in FIG. 2, the rinse mode is activated wherein only fluid from the source line 15 may be supplied to the spray line 42, which is connected to the spray nozzles 45. With the valve 20 oriented in a different position, the source fluid or water travels through the source line 15 and, rather than traveling through the Venturi tube 25 and mixing with the cleaning fluid, the source fluid instead bypasses the Venturi tube 25 in bypass line 65 where it passes through the valve 20 into the spray line 42 and into the manifold 40 where it is distributed through the spray nozzles 45 to rinse the bottles 50. Once again, the fluid falls by gravity into the bottle holders 55 where it is then taken away by a drain line 60.

In a valve third mode, the valve 20 is completely closed and no fluid travels through the source line 15 of the bottle cleaner 10. This is the shut-down mode.

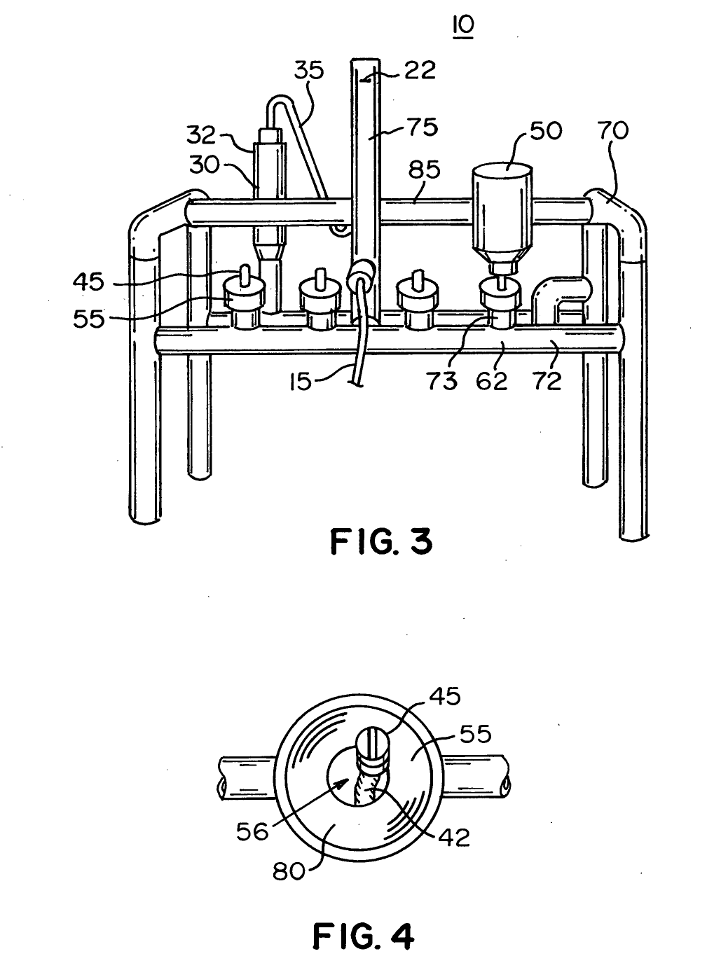

FIG. 3 illustrates the bottle cleaner 10 showing the source line 15 for the source fluid, the cleaning line 35 for the cleaning fluid, and the bottle holders 55 into which bottles 50 may be placed in the inverted position. Also seen in FIG. 3 are the spray nozzles 45 which spray the source fluid and cleaning fluid inside the inverted bottles 50.

The physical routing of the fluid lines occurs within the frame 70 illustrated in FIG. 3. It should be noted that a vertical post 75 extending from the frame 70 contains most of the fluid lines for the bottle cleaner 10 and, as will be discussed, is designed such that the vertical post 75 with the associated internal lines may be removed and replaced as needed. The drain line 60 (FIG. 1) passes within the frame member 72, while each nozzle 45 extends through the frame member 73 associated with the bottle holder 55. The frame 70 may be made of segments of PVC pipes and the fluid lines may be routed within the hollow interior of the pipes. It should be noted that the container 32 for the cleaning fluid 30 is elevated relative to the nozzles 45 to promote flow of the cleaning fluid to the spray nozzles 45. A check valve 36 is located between the cleaning fluid container 32 and the fluid line 15 to prevent backflow.

Note in FIG. 3 that while only one bottle 50 and bottle holder 55 are labeled, these reference numbers apply to each of the bottle holders illustrated therein.

FIG. 3 illustrates the bottle cleaner 10 populated by one bottle 50 in one of the four bottle holders 55. A bottle holder 55 without a bottle 50 may be capped. Although four bottle holders are illustrated in FIG. 3, it should be appreciated that fewer or more bottle holders may be implemented in this bottle cleaner with obvious variations of this design.

FIG. 4 is a top view of a bottle holder 55 used to support an inverted bottle 50 (FIG. 3). Additionally, the bottle holder 55 may be comprised of a collar to support the bottle 50 but also to act as a conduit 56 through which the spray line 42 and the spray nozzle 45 may pass. The bottle holder 55 is connected to the drain line 60 (FIG. 3) such that the residual fluid draining from each bottle may be disposed of through the drain line 60.

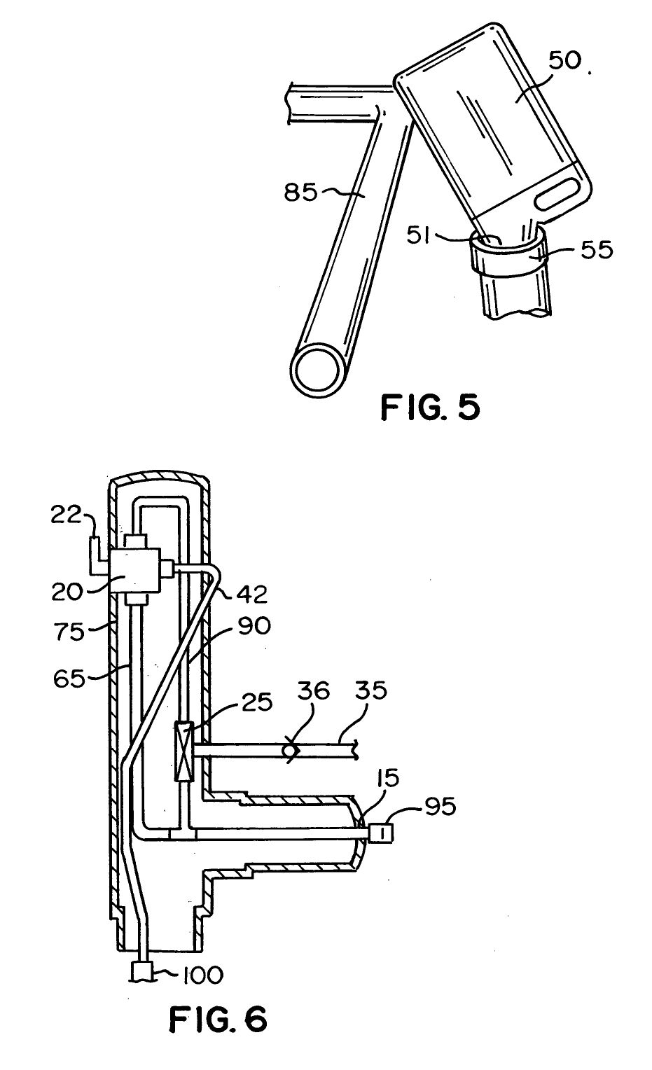

As illustrated in FIGS. 4 and 5, a typical bottle 50 rests within the bottle holder 55 in the inverted position. The width of the bottle holder 55 and the width of the bottle holder drain portion 80 (FIG. 4) must be sufficiently large to permit the neck 51 of the bottle 50 to rest within the bottle holder drain portion 80 while the tapered portion of the bottle 50 may rest within the collar 55. Although not illustrated in FIG. 4, it should be appreciated that the spray nozzle 45 extends into the interior of each bottle 50 mounted within a bottle holder 55. FIG. 5 also illustrates the manner in which a bottle 50 rests within a bottle holder 55. Each bottle 50 may rest against a support bar 85 for additional support. The support bar is a part of the frame 70.

After repeated use of the bottle cleaner 10, or after a period of time, the lines may become dirty or brittle and may need to be replaced. The bottle cleaner 10 includes a replaceable segment 90.

FIG. 6 illustrates a cutaway view of the replaceable segment 90, showing a coupling 95 which connects the front end 16 with the back end 17 of the source line 15 (FIG. 1). A second coupling 100 connects the front end 43 and the back end 44 of the spray line 42 and extends from the bottom of the replaceable segment 90. The segment 90 is removably attached to the frame 70. The cleaning line 35 is used to introduce a cleaning fluid to the fluid traveling through the source line 15. As illustrated in FIG. 1, the end of the cleaning line 35 is placed within the cleaning fluid. Furthermore, FIG. 6 shows the valve 20 which is used to determine the mode of operations of the bottle cleaner 10. The modes, as previously discussed, may be the cleaning mode, the rinse mode, or the shut-down mode. Such mode changes are made by changing the position of the valve 20 using the handle 22. In this situation the valve 20 is a three-way valve.

FIG. 6 also illustrates how the piping fits within the vertical post 75 which is the removable member 90. In particular, the manner in which the pipe shape conforms to the L shape of the vertical post 75 is illustrated. Using reference numbers associated with FIG. 1, the source line 15, depending upon the operating mode defined by the valve 20, permits fluid entering the source line 15 to travel, in the cleaning mode, through the Venturi tube 25 thereby siphoning off and mixing cleaning fluid from the cleaning line 35. The mixed solution then passes through the valve 20 to the spray line 42 on its way to the manifold 40 (not shown). In the alternative, in the rinse mode, source fluid traveling through the source line 15, when the valve 20 is in the second position, bypasses through bypass line 65 the Venturi tube 25 and proceeds directly through the valve 20 to the spray line 42 and to the manifold 40 (not shown). Once the fluid travels through the bypass line 65 through the manifold 40, it is then sprayed within the bottles 50 by the spray nozzles 45 (FIG. 4).

The replaceable segment 90 is easily removable from the bottle washer with the assistance of couplings 95 and 100, which may be quick-connect couplings. As a result, when the components contained within the replaceable segment 90 become worn, it is much more efficient to replace the entire replaceable segment 90 with its internal parts, thereby minimizing the time the bottle washer is unavailable. Quick-connect couplings 95 and 100 are standard commercial parts.

The subject invention has valuable application to the cleaning of residue from bottles used in dialysis procedures.

A method according to the subject invention comprises the steps of mounting at least one bottle in an inverted position over a spray nozzle directed into the interior of the bottle, wherein the spray nozzle is supplied by a spray line. A valve may be moved to one of at least two positions. In a first position, the valve supplies only a pressurized source fluid to a source line fluidly connected to the spray line and introduces source fluid into the interior of the at least one bottle. In a second position, the valve supplies cleaning fluid to the source line through a Venturi tube thereby mixing the cleaning fluid with the source fluid and delivering the mixed fluids to the interior of the at least one bottle.

The invention has been described with reference to the preferred embodiments. Obvious modifications and alterations will occur to others upon reading and understanding the preceding detailed description. It is intended that the invention be construed as including all such modifications and alterations insofar as they come within the scope of appended claims or the equivalents thereof.

The invention claimed is:

1. A bottle cleaner comprising:
a) a bottle holder adapted to hold at least one bottle in an inverted position;
b) a source line connected to a spray line for introducing source fluid into the interior of the at least one bottle;
c) a cleaning line selectively fluidly connected to the source line for introducing cleaning fluid with the source fluid into the at least one bottle; and
d) a valve having at least two positions wherein,
1) in a first position, a cleaning mode is activated wherein the cleaning line is fluidly connected to the source line so that cleaning fluid and source fluid may be combined and supplied to the spray line; and
2) in a second position, a rinse mode is activated wherein only fluid from the source line may be supplied to the spray line.

2. The bottle cleaner according to claim 1, further including a mixer downstream of the intersection of the source line and the cleaning line.

3. The bottle cleaner according to claim 1, further including a mixer at the intersection of the source line and the fluid line.

4. The bottle cleaner according to claim 2, wherein the mixer is a Venturi tube.

5. The bottle cleaner according to claim 4, wherein the Venturi tube has a body adapted for primary flow longitudinally through the body of the Venturi tube and for secondary flow laterally into the body, wherein the source fluid line is aligned with the primary flow and the cleaning fluid line is aligned with the secondary flow such that the secondary fluid is introduced into the body for the vacuum produced by the Venturi tube.

6. The bottle cleaner according to claim 1, further including a drain below the at least one bottle holder adapted to receive fluid exiting from a bottle in the holder.

7. The bottle cleaner according to claim 1, wherein the source fluid is water.

8. The bottle cleaner according to claim 7, wherein the source fluid is tap water under pressure.

9. The bottle cleaner according to claim 1, wherein the cleaning fluid is bleach.

10. The bottle cleaner according to claim 1, further including a manifold between the source line and the spray nozzles.

11. The bottle cleaner according to claim 10, wherein there are multiple bottle holders attached to the manifold with a spray nozzle extending from each bottle holder.

12. The bottle cleaner according to claim 11, further including a hollow pipe frame supporting the manifold and wherein the fluid lines are routed through the hollow interior of the pipes.

13. The bottle cleaner according to claim 1, further including a cleaning fluid container fluidly connected to the cleaning line.

14. The bottle cleaner according to claim 13, wherein the fluid container is mounted above the elevation of the at least one spray nozzle to assist with the flow of cleaning fluid into the at least one spray nozzle.

15. The bottle holder according to claim 1, wherein each of the source line and the spray line has a front end and a back end with a detachable quick connect coupling therebetween.

16. The bottle holder according to claim 15, wherein the back end of the source line and the front end of the spray line define a removable segment that may be easily replaced.

17. The bottle holder according to claim 1, wherein the valve includes a third position for a shut-down mode in which neither the source line nor the cleaning line are fluidly connected to the spray line.

18. The bottle cleaner according to claim 1, wherein each bottle holder is comprised of an over-sized collar adapted to accept and retain a bottle.

19. A bottle cleaner comprising:
a) multiple bottle holders, each adapted to hold a bottle in an inverted position;
b) a source line connected to a spray line for introducing source fluid into the interior of the at least one bottle;
c) a cleaning line selectively fluidly connected to the source line for introducing cleaning fluid with the source fluid into the at least one bottle;
d) a valve having at least two positions wherein,
1) in a first position, a rinse mode is activated wherein only fluid from the source line may be supplied to the spray line, and;
2) in a second position, a cleaning mode is activated wherein the cleaning line is fluidly connected to the source line so that cleaning fluid and source fluid may be combined and supplied to the spray line;
e) a mixer at the connection between the source line and the fluid line, wherein the mixer is a Venturi tube with a body adapted for primary flow longitudinally through the body of the Venturi tube and secondary flow laterally into the body, wherein the source fluid line is aligned with the primary flow and the cleaning fluid line is aligned with the secondary flow; and
f) a spray nozzle extending within each bottle holder adapted for spraying fluid into a bottle mounted within the bottle holder.

20. A method for cleaning bottles containing residual dialysis fluid comprising the steps of:
a) mounting at least one bottle in an inverted position over a spray nozzle directed into the interior of the bottle, wherein the spray nozzle is supplied by a spray line;
b) moving a valve to a first position, thereby supplying only a pressurized source fluid to a source line fluidly connected to the spray line thereby introducing source fluid into the interior of the at least one bottle; and
c) moving the valve to a second position, thereby supplying cleaning fluid line to the source line through a Venturi tube thereby mixing the cleaning fluid with the source fluid and delivering the mixed fluids into the interior of the at least one bottle.

21. The method according to claim 20, further including the step of directing to a drain the fluid exiting the inverted bottles.
